(19) United States
(12) Patent Application Publication
(10) Pub. No.: US 2026/0222133 A1
(43) Pub. Date: Jul. 30, 2026

(54) DEVICE, METHOD AND COMPUTER READABLE MEDIUM FOR RADIO LINK RESOURCE CONFIGURATION

(71) Applicant: NEC CORPORATION, Tokyo (JP)

(72) Inventors: Xincai LI, Beijing (CN); Gang WANG, Beijing (CN)

(73) Assignee: NEC CORPORATION, Tokyo (JP)

(21) Appl. No.: 19/147,592

(22) PCT Filed: Jan. 17, 2023
(86) PCT No.: PCT/CN2023/072725

§ 371 Date: Jul. 11, 2025

(51) Int. Cl. H04L 5/00

(52) U.S. Cl. CPC H04L 5/0044; H04L 5/0005

(57) ABSTRACT

Embodiments of the present disclosure relate to devices, methods and computer readable medium for a radio link resource configuration. According to embodiments of the present disclosure, a terminal device receives an uplink resource configuration from a network device. The uplink resource configuration is associated with a first resource set within an uplink frequency subband of a SBFD time unit and a second resource set within a non-SBFD time unit. The SBFD time unit is configured with frequency subbands for different link directions. The terminal device transmits an uplink control channel on at least one of the first resource set and the second resource set to the network device.

### FIELD

Embodiments of the present disclosure generally relate to the field of communication, and in particular, to devices, methods and computer readable medium for a radio link resource configuration.

### BACKGROUND

With the development of communication technology, a time unit (for example, a symbol, slot, frame, sub-frame and so on) can be divided into a plurality of frequency subbands in the frequency domain. The plurality of frequency subbands may be respectively used for different link directions, for example, uplink (UL) or downlink (DL). This time unit may be also referred to as subband non-overlapping full duplex (SBFD) time unit. In turn, a device for communication (for example, a network device or a terminal device) may perform the simultaneous transmission and reception of channel in different link directions on these time units, in order to improve communication efficiency.

In a communication system, a set of physical-layer control channels is configured for carrying scheduling decisions in the downlink and to provide feedback information in the uplink. In turn, the efficiency transmission of the control channels is important for the communication system. The resource allocation for the control channels may be further optimized for the introduced SBFD time units.

### SUMMARY

In general, example embodiments of the present disclosure relate to devices, methods, and computer readable medium for radio link resource configuration.

In a first aspect, there is provided a terminal device. The terminal device comprises a transceiver and a processor communicatively coupled to the transceiver. The processor is configured to cause the terminal device to: receive an uplink resource configuration from a network device. The uplink resource configuration is associated with a first resource set within an uplink frequency subband of a SBFD time unit and a second resource set within a non-SBFD time unit. The SBFD time unit is configured with frequency subbands for different link directions. The terminal device is further caused to transmit an uplink control channel on at least one of the first resource set and the second resource set to the network device.

In a second aspect, there is provided a network device. The network device comprises a transceiver and a processor communicatively coupled to the transceiver. The processor is configured to cause the network device to: transmit an uplink resource configuration to a terminal device. The uplink resource configuration is associated with a first resource set within an uplink frequency subband of a SBFD time unit and a second resource set within a non-SBFD time unit. The SBFD time unit is configured with frequency subbands for different link directions. The network device is further caused to receive an uplink control channel on at least one of the first resource set and the second resource set from the terminal device.

In a third aspect, there is provided a method implemented at a terminal device. In the method, the terminal device receives an uplink resource configuration from a network device. The uplink resource configuration is associated with a first resource set within an uplink frequency subband of a SBFD time unit and a second resource set within a non-SBFD time unit. The SBFD time unit is configured with frequency subbands for different link directions. The terminal device transmits an uplink control channel on at least one of the first resource set and the second resource set to the network device.

In a fourth aspect, there is provided a method implemented at a network device. In the method, the network device transmits an uplink resource configuration to a terminal device. The uplink resource configuration is associated with a first resource set within an uplink frequency subband of a SBFD time unit and a second resource set within a non-SBFD time unit. The SBFD time unit is configured with frequency subbands for different link directions. The network device receives an uplink control channel on at least one of the first resource set and the second resource set from the terminal device.

In a fifth aspect, there is provided a computer readable medium having instructions stored thereon, the instructions, when executed on at least one processor, causing the at least one processor to perform the method of the third aspect or the fourth aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example environment in which some embodiments of the present disclosure can be implemented;

FIG. 1B illustrates an example timing requirement between downlink transmissions and uplink transmissions;

FIG. 1C illustrates an example multiplexing procedure for a plurality of PUCCH in non-SBFD time units;

FIG. 2 illustrates a signaling process for configuring uplink control channel resources in SBFD time units and non-SBFD time units according to some embodiments of the present disclosure;

FIGS. 3A to 3B illustrate example starting resource block (RB) offset and frequency hopping resource block offset between SBFD time unit and non-SBFD time unit according to some embodiments of the present disclosure;

FIG. 3C illustrates a disabling of an intra-slot or inter-slot frequency hopping within the first resource set according to some embodiments of the present disclosure;

FIGS. 4A to 4B illustrate the uplink control channels transmitted across SBFD time unit and non-SBFD time unit according to some embodiments of the present disclosure;

FIG. 5 illustrates an example multiplexing procedure of a plurality of uplink control channels in SBFD time units and non-SBFD time units according to some embodiments of the present disclosure;

FIGS. 6A and 6B illustrate example hybrid automatic repeat request-acknowledge (HARQ-ACK) codebooks in SBFD time units and non-SBFD time units according to some embodiments of the present disclosure;

FIGS. 7A to 7C illustrate examples of uplink control channel repetitions on SBFD time units and non-SBFD time units according to some embodiments of the present disclosure;

FIG. 8 illustrates example physical uplink control channel resource indicators (PRI) and transmit power control (TPC) commands for indicating uplink control channel resources on SBFD time units and non-SBFD time units according to some embodiments of the present disclosure;

FIG. 9 illustrates a flowchart of an example method implemented at a terminal device according to some embodiments of the present disclosure;

FIG. 10 illustrates a flowchart of an example method implemented at a network device according to some embodiments of the present disclosure; and

FIG. 11 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may be also incorporated one or multiple Subscriber Identity Module (SIM) as known as Multi-SIM. The term “terminal device” can be used interchangeably with a UE, a mobile station, a subscriber station, a mobile terminal, a user terminal, a wireless device or a reduced capability terminal device.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information. The terminal or the network device may work on several frequency ranges, e.g. FR1 (410 MHz-7125 MHz), FR2 (24.25 GHz to 71 GHz), 71 GHz to 114 GHz, and frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware. In this disclosure, the subband and the frequency subband may be used interchangeable without any limitation. The group size of a RBG may be also referred to as the RBG size without any limitation. The time unit configured with SBFD communication may be also referred to as SBFD time unit, and the time unit not configured with SBFD communication may be also referred to as non-SBFD time unit. In this disclosure, the control channel may be interchangeably used with the physical downlink control channel (PDCCH) without any limitation. In this disclosure, the time unit may be any time duration, for example, symbol, slot and frame and so on.

As mentioned above, the resource allocation for the control channels may be further optimized for the newly introduced SBFD time units. For example, the network device may schedule a terminal device to transmit the uplink control channel (for example, physical uplink control channel, PUCCH) in the SBFD time unit. In this case, the terminal device does not have to wait for a UL time unit for transmitting the PUCCH. In turn, the network device may receive the PUCCH timely. In this way, the performance of the communication system can be improved. However, the PUCCH resource allocation related to the SBFD should be carefully designed, since the uplink resource allocated for the PUCCH may overlap with the downlink frequency subband of the SBFD. In addition, the PUCCH resource allocation for the SBFD time unit should be also coordinated with that for the non-SBFD time unit.

At least for solving the above technical issues, the example embodiments of the disclosure propose a mechanism for configuring uplink resources for the uplink control channel in the SBFD time unit and non-SBFD time unit. In this mechanism, a terminal device receives an uplink resource configuration from a network device. The uplink resource configuration is associated with a first resource set within the uplink frequency subband of the SBFD time unit. The uplink resource configuration is also associated with a second resource set within the non-SBFD time unit. Then, the terminal device transmits the uplink control channel on at least one of the first resource set and the second resource set to the network device.

In this way, by means of this uplink resource configuration associated with both the first resource set in the SBFD time units and the second resource set the non-SBFD time units, the terminal device may determine the resources for the uplink control channel in different types of time units. Then, the terminal device may transmit the uplink control channel adaptively (for example, the uplink control channel will not be transmitted on the downlink frequency subband of the SBFD time unit). In addition, the uplink control channel crossing different types of time units can be also coordinated based on this uplink resource configuration.

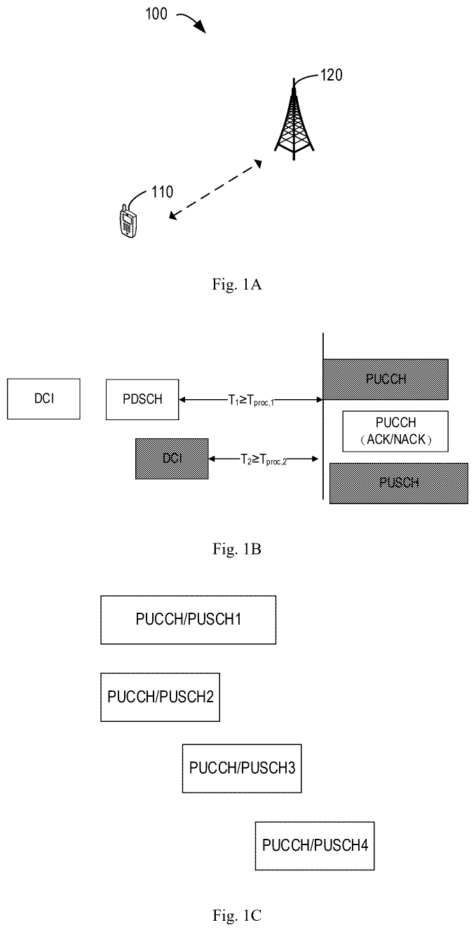

For illustrative purposes, principle and example embodiments of the present disclosure will be described below with reference to FIGS. 1A-9. However, it is to be noted that these embodiments are given to enable the skilled in the art to understand inventive concepts of the present disclosure and implement the solution as proposed herein, and not intended to limit scope of the present application in any way.

FIG. 1A illustrates an example environment 100 in which example embodiments of the present disclosure can be implemented.

The environment 100, which may be a part of a communication network, comprises a terminal device 110 and a network device 120. In some embodiments, the communication network may include NTN, NB-IoT and/or eMTC. In some other embodiments, the communication network may include any other possible communication network. It is to be understood that the number of network devices and terminal devices is given only for the purpose of illustration without suggesting any limitations. The communication network may include any suitable number of network devices and/or terminal devices adapted for implementing embodiments of the present disclosure. Although not shown, it would be appreciated that one or more terminal devices may be located in the environment 100. Without any limitation, the network device 120 supports the SBFD communication. For example, the network device 120 may transmit DL channel to the terminal device 110 and receive UL channel from another terminal device (not shown in FIG. 1A) in the SBFD time unit, simultaneously. In this disclosure, the physical uplink control channel (PUCCH) and the uplink control channel may be used interchangeably without any limitation. In this disclosure, the non-SBFD time unit may be UL only time unit or DL only time unit.

FIG. 1B illustrates an example timing requirement between downlink transmissions and uplink transmissions.

As shown in FIG. 1B, the uplink channel transmission and the previous downlink channel transmission corresponding to the uplink channel transmission should satisfy the timing requirement. In some embodiments, a timing requirement of uplink control channel comprising a hybrid automatic repeat request-acknowledge (HARQ-ACK) is semi-statically configured. In this case, the terminal device may determine the time unit for transmitting the HARQ-ACK of a received shared channel repetition accordingly. In this disclosure, the semi-configured HARQ-ACK uplink control channel may be also referred to as a HARQ-ACK codebook having a first type. Alternatively, the HARQ-ACK uplink control channel may be also dynamically indicated by a downlink control information (DCI) signaling. That is, the DCI signaling may indicate on which time unit the HARQ-ACK for a received shared channel repetition is transmitted. In this disclosure, the dynamically determined HARQ-ACK codebook may be also referred to as the HARQ-ACK having a second type. The HARQ-ACK having different types may be carefully configured for the SBFD time unit and non-SBFD time unit, and the adaption is further discussed in the following.

FIG. 1C illustrates an example multiplexing procedure for a plurality of PUCCH in non-SBFD time units.

In some embodiments, if the terminal device is to transmit a plurality of PUCCHs partially overlapping in time domain with each other, the terminal device may multiplex the plurality of PUCCHs as shown in FIG. 1C into one multiplexed PUCCH. Then, the terminal device may only transmit this one multiplexed PUCCH instead of the plurality of PUCCHs. Similarly, with the new introduced SBFD time unit, the multiplexing procedure may be further optimized.

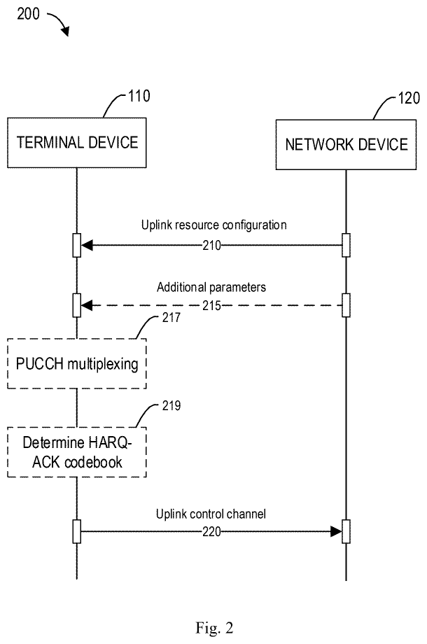

FIG. 2 illustrates a signaling process 200 for configuring uplink control channel resources in SBFD time units and non-SBFD time units according to some embodiments of the present disclosure. For illustrative purposes, the process 200 will be described with reference to FIG. 1.

In the signaling process 200, the network device 120 transmits (210) an uplink resource configuration to the terminal device 110. The uplink resource configuration is associated with a first resource set within an uplink frequency subband of SBFD time unit and a second resource set within a non-SBFD time unit.

In some embodiments, the uplink resource configuration includes a common or shared resource configuration. The uplink control channel resources within the non-SBFD time unit (for example, the time unit only used for uplink) may be indicated only by the common or shared resource configuration. The uplink control channel resources within the SBFD time unit may be indicated by the common or shared resource configuration and additional parameters. In this disclosure, the uplink control channel resources allocated in the SBFD time unit may be also referred to as the first resource set. The uplink control channel resources allocated in the non-SBFD time unit may be also referred to as the second resource set. Alternatively, in some other embodiments, the uplink resource configuration may comprise a SBFD resource configuration indicating the first resource set and a non-SBFD resource configuration indicating the second resource set. In this case, the SBFD resource configuration and the non-SBFD resource configuration are determined independently. For discussion clarity, the independently determined SBFD resource configuration and non-SBFD resource configuration will be discussed in the following. The common or shared resource configuration and additional parameters is discussed at first.

In an example, the above common or shared resource configuration may be a common resource set identification (ID) indicating the second resource set. In addition, the transmitted uplink resource configuration may further comprise the additional parameters for indicating the first resource set. The additional parameters may be only enabled for the SBFD time units. When the terminal device 110 is to transmit the uplink control channel on the non-SBFD time unit, the terminal device may determine the second resource set without considering the additional parameters. In turn, the terminal device 110 may determine the first resource set based on the common resource set ID and the additional parameters, when transmitting the uplink control channel on the SBFD time unit. In some embodiments, the additional parameters may include: starting resource block parameter for the uplink control channel on the first resource set, intra slot frequency hopping parameter for the uplink control channel on the first resource set, second hopping resource block parameter for the uplink control channel on the first resource set, power control parameter for the uplink control channel, spatial beam parameter for the uplink control channel, and/or path loss reference signal parameter for the uplink control channel.

In this way, if the second resource set overlaps with the configured downlink frequency subband of the SBFD time unit, the first resource set may be adjusted into the uplink frequency subband of the SBFD time unit based on the combination of the common resource set ID and the additional parameters. As such, the configured uplink control channel (for example, PUCCH) resource set and uplink control channel resource list in each set is common or shared for SBFD symbols and non-SBFD symbols. Moreover, some PUCCH parameters for SBFD symbols and non-SBFD symbols are separately configured. Alternatively, additional configurations are added for each PUCCH resource ID, such that the terminal device 110 could use different parameters to transmit PUCCH on SBFD symbol. For example, for the SBFD symbols, a new set of parameters for power control, resources in frequency domain, physical layer (PHY) priority, beam (spatialRelationInfo) are additionally configured.

The above embodiments may be also expressed as below. Below IE can be added in the PUCCH-Config for SBFD symbols.

```
startingPRB-SBFD PRB-Id,
    intraSlotFrequencyHopping ENUMERATED { enabled }
    secondHopPRB-SBFD PRB-Id,
PUCCH-PowerControlSetInfo-SBFD ::= SEQUENCE {
p0-PUCCH-Id-SBFD P0-PUCCH-Id,
  pucch-ClosedLoopIndex-SBFD ENUMERATED { i0, i1 },
pucch-PathlossReferenceRS-Id-SBFD PUCCH-PathlossReferenceRS-Id
  }
  pucch-SpatialRelationInfoId-SBFD ::= SEQUENCE {
    pucch-SpatialRelationInfoId-SBFD OPTIONAL,
  pucch-PathlossReferenceRS-Id-SBFD pucch-PathlossReferenceRS-
Id-SBFD }
```

In some embodiments, the additional parameter may include a starting resource block offset value. The starting resource block of the PUCCH in the first resource set may be determined based on the starting resource block of the PUCCH in the second resource set and the starting resource block offset value. For example, the starting resource block of the PUCCH in the first resource set may be obtained based on shifting the starting resource block of the second resource set by the starting resource block offset value. The starting resource block offset value may be preconfigured, for example, preconfigured as zero “0”. In this case, if the starting resource block offset value is preconfigured as zero, the starting resource block of the PUCCH in the second resource set may be as same as the starting resource block of the PUCCH in the first resource set. Without any limitation, the starting resource block offset value may be preconfigured as other values. In an example, the starting resource block offset value is preconfigured by a radio resource control signaling.

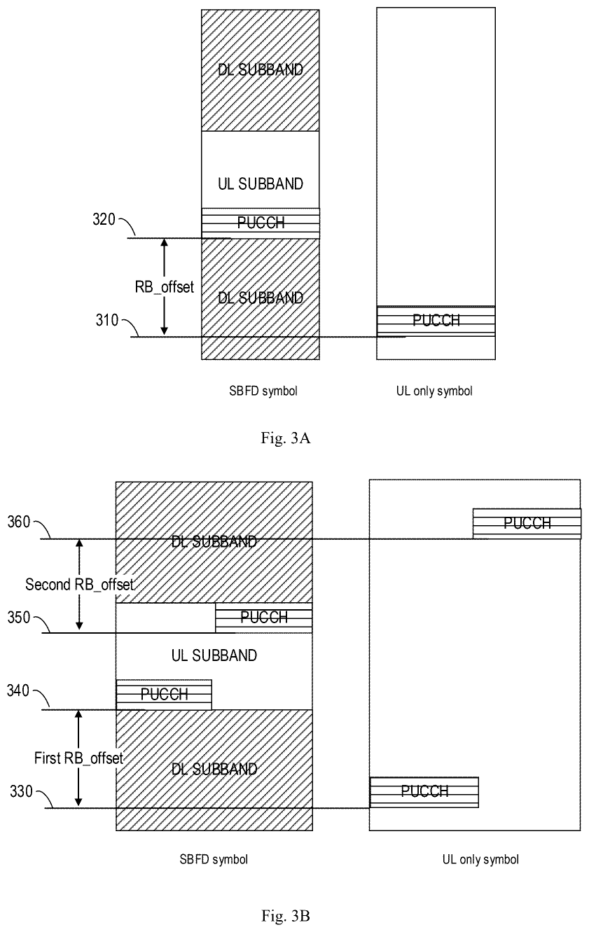

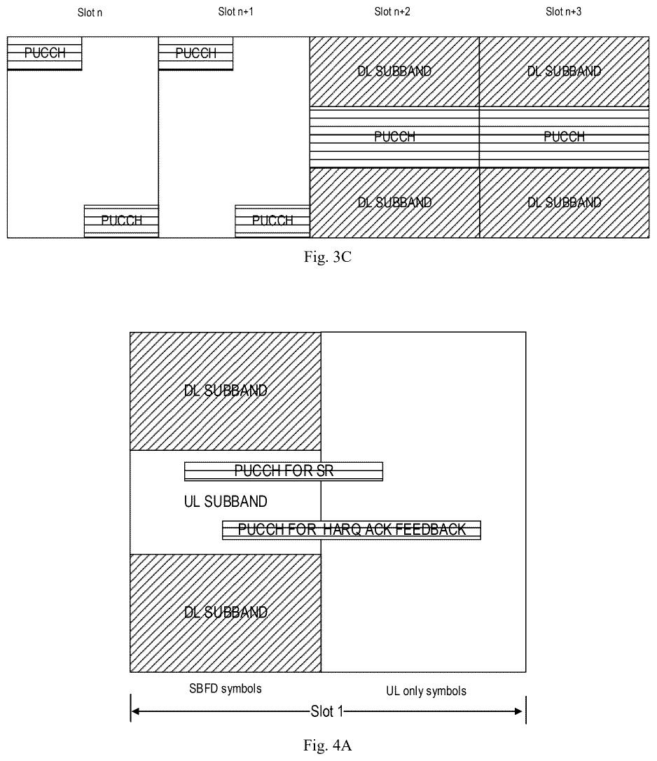

In addition, the starting resource block offset value may be further updated or indicated by the downlink control information (DCI) signaling. For example, if the starting resource block offset value is preconfigured as zero and the resource block of the PUCCH in the second resource set is out of the UL subband boundary in the SBFD symbols in the frequency domain, then the network device 120 may transmit (215) the updated starting resource block offset value in the DCI signaling to the terminal device 110. In the SBFD symbols, this indicated starting resource block offset value is applied to the starting resource block of the PUCCH in the first resource set to obtain the starting resource block of the PUCCH resource set within the uplink frequency subband. For illustration purposes, the starting resource block offset value is further discussed with reference to FIG. 3A.

FIG. 3A illustrates example starting RB offset between SBFD time unit and non-SBFD time unit according to some embodiments of the present disclosure.

As shown in FIG. 3A, the second resource set (which is shown as the PUCCH in the UL only symbols) indicated by the common resource set ID overlaps with the downlink frequency subband of the SBFD in the frequency domain. Then, the starting resource block offset value may be further updated, configured or indicated based on the UL subband position in SBFD symbols. In an example, a new bit field indicating the starting resource block (RB) offset value may be added in the DCI signaling. The indicated starting RB offset value may be applied to the starting frequency position 310 of the PUCCH in the UL only time unit, in order to obtain the first resource set (which is shown as the PUCCH in the SBFD time unit in FIG. 3A) in the SBFD time unit. The starting frequency position 320 of the PUCCH in the SBFD time unit is obtained by shifting the starting frequency position 310 by the indicated starting RB offset value. As such, the PUCCH frequency bandwidth (BW) can be ensured to be contained within the UL subband during SBFD time units. Only as an example, the configured PUCCH frequency position for UL only time unit is start from the fifth resource block of the bandwidth part (BWP), and the RB offset value is four, then the starting PRB of the first resource set in the SBFD time unit is the ninth resource block of the BWP, such that the PUCCH is located within the UL frequency subband.

Referring back to FIG. 2, the uplink resource configuration may also comprise frequency hopping indication. For example, the uplink resource configuration may indicate intra-slot and inter-slot PUCCH frequency hopping. Specifically, if the uplink resource configuration is associated with the intra-slot or inter-slot frequency hopping, then the terminal device 110 should enable the intra-slot or inter-slot frequency hopping within the second resource set during the non-SBFD time units accordingly, such that the second resource set may include two frequency hopping resources. In this case, the terminal device 110 may also enable the intra-slot or inter-slot frequency hopping within the first resource set, such that the first resource set in SBFD symbols comprises a first frequency hopping resource and a second frequency hopping resource. However, the frequency hopping as same as that within the second resource set may be not fit for the first resource set during the SBFD time units. In this case, the additional parameters may include a second hopping RB offset value for adjusting the second hopping resource of the first resource set. For illustration purposes, the adjustment of the second hopping resource within the first resource set is further discussed with reference to FIG. 3B.

FIG. 3B illustrates example frequency hopping resource block offset between SBFD time unit and non-SBFD time unit according to some embodiments of the present disclosure. As shown in FIG. 3B, in addition to the starting resource block offset value as mentioned above, the additional parameters may further include a second hopping resource block offset value. In some embodiments, if the common resource set ID is associated with intra-slot or inter-slot frequency hopping, then the terminal device 110 may enable the intra-slot or inter-slot frequency hopping within the first resource set after receiving (210) the uplink resource configuration. In this case, the first resource set may include a starting frequency hopping resource and a second hopping resource. The starting frequency hopping resource (which is shown as starting from the frequency position 340 in FIG. 3B) of the first resource set may be determined based on another starting frequency hopping resource (which is shown as starting from the frequency position 330 in FIG. 3B) of the second resource set and the starting RB offset value (which is shown as first RB_offset in FIG. 3B). Further, the second frequency hopping resource (which is shown as starting from the frequency position 360 in FIG. 3B) may be determined based on another second frequency hopping resource (which is shown as starting from the frequency position 360 in FIG. 3B) of the second resource set and the second hopping RB offset value (which is shown as second RB_offset in FIG. 3B).

In this way, at least one of the above two RB offset values (i.e., the starting RB offset value and the second hopping RB offset value) can be configured by RRC or indicated in the DCI. The configured or indicated RB offset values may be applied by the terminal device 110 to determine the PUCCH frequency position in the SBFD symbols, in order to ensure that the PUCCH is within the UL frequency subband bandwidth. In an example, for intra-slot frequency hopping, two RB offsets “first RB_offset and “second RB_offset” are configured by RRC or indicated in the DCI, such that the frequency position for PUCCH transmission during the SBFD symbols can be located within the UL frequency subband BW. In addition or alternatively, the second hopping RB offset value may be configured, such that the second hopping starting PRB index is near the upper boundary of the UL subband. Without any limitation, the starting RB offset value and second hopping RB offset value may be negative values.

Referring back to FIG. 2, in addition or alternatively to the starting RB offset and the second hopping RB offset value between the first resource set (for the SBFD time unit) and the second resource set (for the non-SBFD time unit), a frequency hopping resource block number between the first frequency hopping resource and the second frequency hopping resource of the first resource set may be further adjusted.

As mentioned above, if the uplink resource configuration is associated with the intra-slot or inter-slot hopping, the terminal device 110 may enable the intra-slot or inter-slot frequency hopping within the first resource set, such that the first resource set comprises a first frequency hopping resource and a second frequency hopping resource. In some embodiments, the terminal device 110 may determine a frequency hopping resource block number between the first frequency hopping resource and the second frequency hopping resource based on the number of resource blocks in the uplink frequency subband of the SBFD time unit. In an example, the frequency hopping resource block number may be (the number of resource blocks in the uplink frequency subband of the SBFD time unit)/2″ or (the number of resource blocks in the uplink frequency subband of the SBFD time unit)/4″. Without any limitation, if the bandwidth of the uplink frequency subband is large, then the larger RB_offset can be configured. Else if the bandwidth of the uplink subband is small, then the smaller RB_offset may be configured for the terminal device 110 to perform the frequency hopping in the SBFD symbols.

In addition, the frequency hopping resource block number may be determined based on modulo operation. In this case, the frequency hopping resource block number may be calculated by calculating:

$$( secondHopPRB + RB\_offset ) mod ( {N}_{ul \_ subband} - R {B}_{pucch} ) \qquad ( 1 )$$

wherein the secondHopPRB is the number of RBs in the second frequency hopping resource;
the RB_offset is configured or indicated second frequency hopping resource block offset value between the SBFD time unit and the non-SBFD time unit;
the N_{ul_subband} is the number of RBs in the uplink frequency subband of the SBFD time unit; and
RB_{pucch}-is the total number of RBs of a PUCCH scheduled in the first resource set.

In this way, intra-slot frequency hopping for PUCCH formats 1, 3, or 4 can be configured for the SBFD time units. As mentioned above, for the intra-slot and inter-slot PUCCH frequency hopping within the SBFD symbols, the BW of the frequency hopping should not exceed the BW of the UL subband in the SBFD symbols. The location of the hoppings in the SBFD symbols may be adjusted by the above mechanisms if the frequency hoppings are out of the UL subband boundary.

Alternatively, even if the uplink resource configuration is associated with the intra-slot or inter-slot frequency hopping, the terminal device 110 may disable the frequency hopping during the SBFD time units. For example, the number of RBs within the uplink frequency subband of the SBFD time units is not enough to support the intra-slot or inter-slot frequency hopping. For illustration purposes, the disabling of the frequency hopping within the first resource set is discussed with reference to FIG. 3C.

FIG. 3C illustrates a disabling of an intra-slot or inter-slot frequency hopping within the first resource set according to some embodiments of the present disclosure.

As shown in FIG. 3C, if the second frequency hopping resource of the PUCCH resource overlaps with the DL subband of the SBFD time units, then the terminal device 110 may disable the intra-slot or inter-slot frequency hopping in SBFD slots even the intra-slot or inter-slot frequency hopping is configured for PUCCH. In this case, the PUCCH will be transmitted on the pre-configured frequency position on the SBFD slots. For example, for PUCCH format 3 occupying 16RBs, if the intra-slot frequency hopping is configured, the repetition factor is 4 and the RB number of the uplink subband is 16, then the intra-slot frequency hopping will be disabled in the SBFD symbols. In turn, in other non-SBFD slots, the intra-slot frequency hopping is still valid.

Referring back to FIG. 2, as mentioned above, the uplink resource configuration may also directly comprise a SBFD resource configuration indicating the first resource set and a non-SBFD resource configuration indicating the second resource set. Moreover, the SBFD resource configuration and the non-SBFD resource configuration are determined independently.

In some embodiments, a special PUCCH resource set, such as PUCCH-ResourceSet-SBFD can be configured for the SBFD-aware terminal device. A list of PUCCH resource is included in this set for the terminal device to determine the PUCCH resource on the SBFD time units. In addition or alternatively, more PUCCH resource may be added for each PUCCH resource set. Moreover, some PUCCH resources in each PUCCH resource set is used for PUCCH transmission on SBFD time units. If the number of PUCCH resource in the PUCCH resource set is larger than 8, then the terminal device 110 may determine the PUCCH resource ID according to the control channel element (CCE) number, the smallest CCE index and the PUCCH resource indicator (PRI).

The above embodiments may be also expressed as below:

PUCCH-ResourceSet-SBFD ::= SEQUENCE {

| | |
|---|---|
| pucch-ResourceSetId | PUCCH-ResourceSetId, |

```
  resourceList SEQUENCE (SIZE (1..maxNrofPUCCH-ResourcesPerSet)) OF
PUCCH-ResourceId, }
  PUCCH-resource-SBFD ::= SEQUENCE {
```

| | |
|---|---|
| pucch-ResourceId | PUCCH-ResourceId, |
| startingPRB-SBFD | PRB-Id, |

intraSlotFrequencyHopping ENUMERATED { enabled }

| | |
|---|---|
| secondHopPRB-SBFD | PRB-Id, |

| | |
|---|---|
| format | CHOICE {format0, format1, format2, format3, format4} |

```
    }
  For PUCCH format 2 and 3, UE does not expect the allocated RB number exceed the
number of RB included in the UL subband in the SBFD symbols.
  These PUCCH resource IDs can be configured to transmit SR, the P-CSI report and
DCI indicated HARQ-ACK feedback transmission.
```

Then, as shown in FIG. 2, after receiving (210) the uplink resource configuration and receiving (215) the additional parameters from the network device 120, the terminal device 110 may be aware of the first resource set in the SBFD time units and the second resource set in the non-SBFD time units. Then, the terminal device 110 transmits (220) an uplink control channel on at least one of the first resource set and the second resource set to the network device 120.

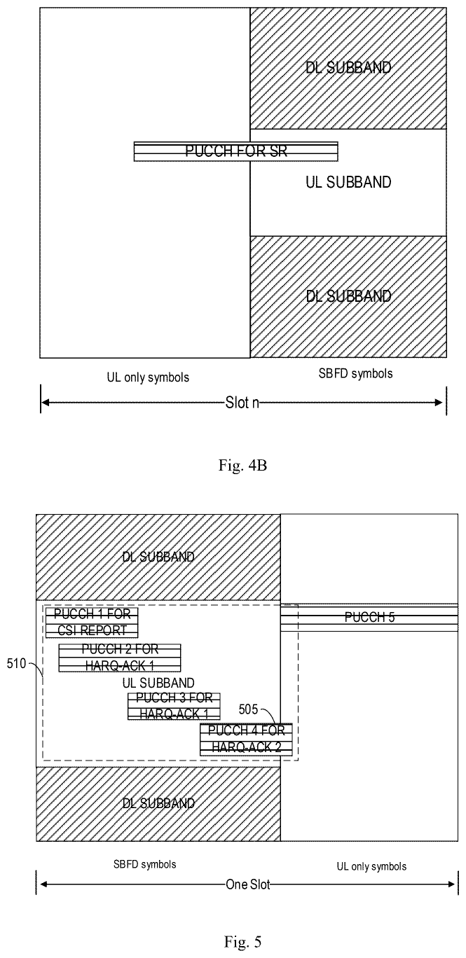

In some embodiments, the scheduled PUCCH may cross the boundary of the non-SBFD time units and the SBFD time units. In this case, if the first resource set within the SBFD is not separately indicated (for example, the first resource set is indicated by the common resource set ID and additional parameters as mentioned above), the terminal device 110 may transmit the scheduled PUCCH across the boundary. For illustration purposes, the scheduled PUCCH crossing the boundary is discussed with reference to FIGS. 4A and 4B.

FIGS. 4A to 4B illustrate the uplink control channels transmitted across SBFD time unit and non-SBFD time unit according to some embodiments of the present disclosure.

As shown in FIGS. 4A and 4B, if PUCCH resource is not separately configured, the SBFD symbols is less than the configured number of PUCCH symbols and the next symbols is UL only symbols in a slot, then the PUCCH may cross the boundary between the SBFD symbols and the UL symbols.

As an example (as shown in FIG. 4A), some SBFD symbols are configured at the last of a slot. In this case, if the PUCCH time duration is larger than the previous UL symbols in the slot, then the PUCCH may be transmitted across the boundary between the SBFD and non-SBFD symbols.

In another example (as shown in FIG. 4B), if the configured resources for a scheduling request (SR) in a PUCCH transmission is PUCCH format 1 occupying 8 symbols, the startingsymbolIndex of this PUCCH resource is symbol #5 and the duration of the SBFD symbols is 8, then this PUCCH will be transmit extending to the UL symbols.

Alternatively, if the PUCCH duration crosses the SBFD symbol boundary and the PUCCH resources is separately configured for the SBFD time unit and the non-SBFD time unit (for example, the first resource set and the second resource set as mentioned above), then the PUCCH will be cancelled or dropped by the terminal device 110.

As mentioned above with reference to FIG. 1C, the multiplexing procedure of the PUCCHs may be adjusted for the SBFD time units. In some embodiments, if the first resource set and the second resource set are separately configured, the terminal device 110 may multiplex (217) a first plurality of uplink control channels having at least one uplink control information (UCI) type within the SBFD time unit to be a first multiplexed uplink control channel. In turn, for the non-SBFD time unit, the terminal device 110 may multiplex (217) a second plurality of uplink control channels having at least one uplink control information (UCI) type to be a second multiplexed uplink control channel. Then, the terminal device 110 transmits (220) to the network device 120 the first multiplexed uplink control channel on the first resource set and the second multiplexed uplink control channel on the second resource set separately.

That is, if the first resource set and the second resource set are separately configured, the PUCCH multiplexing procedure may be separately operated for the SBFD symbols and non-SBFD symbols in one slot. Alternatively, if the first resource set and the second resource set are not configured separately, the PUCCHs in the SBFD time units and the PUCCHs in the non-SBFD time units may be multiplexed according to the existing rule (for example, may be multiplexed into the same one multiplexed PUCCH). For illustration purposes, the multiplexing procedure may be discussed with reference to FIG. 5.

FIG. 5 illustrates example an example multiplexing procedure of a plurality of uplink control channels in SBFD time units and non-SBFD time units according to some embodiments of the present disclosure.

As shown in FIG. 5, if the first resource set and the second resource set are configured separately, the terminal device 110 may multiplex the PUCCH 1 to PUCCH 3 into a first multiplexed PUCCH and drop PUCCH 4 crossing the boundary. Then, the terminal device 110 may transmit the first multiplexed PUCCH during the SBFD symbols and transmit the PUCCH 5 during the UL symbols. Otherwise, if the first resource set and the second resource set are not configured separately, the terminal device 110 may multiplex (217) the PUCCH 1 to PUCCH 5 according the existing rule.

The above embodiments may be also expressed as below:

If a UE would transmit multiple overlapping PUCCHs in a slot or SBFD symbols or
overlapping PUCCH(s) and PUSCH(s) in a slot or SBFD symbols and, when applicable as
described in clauses 9.2.5.1 and 9.2.5.2, the UE is configured to multiplex different UCI
types in one PUCCH, and at least one of the multiple overlapping PUCCHs or PUSCHs is
in response to a DCI format detection by the UE, the UE multiplexes all corresponding
UCI types if the following conditions are met. And the multiplexing procedure is separately
performed for SBFD and non-SBFD symbols.

Referring back to FIG. 2, for the SBFD time units and the non-SBFD time units, the HARQ-ACKs for the PUCCH transmission can be designed accordingly.

In some embodiments, for the HARQ-ACK codebook having the first type (for example, type 1), the terminal device 110 may transmit a first HARQ-ACK codebook on the first resource set. The first HARQ-ACK is dedicatedly configured for a downlink shared channel transmitted on at least one previous SBFD time unit. In turn, the terminal device 110 may further transmit a second HARQ-ACK codebook having the first type on the second resource set. The different is that the second HARQ-ACK is dedicatedly configured for a downlink shared channel transmitted on at least one previous non-SBFD time unit. That is, for the HARQ-ACK having the first type, the HARQ-ACK codebook in a time unit having a certain type is specific to the downlink data in at least one previous time unit having the same type (for example, the SBFD time unit or the non-SBFD time unit). In this way, the HARQ-ACK codebook having the first type may be determined (219) by the terminal device 110 accordingly.

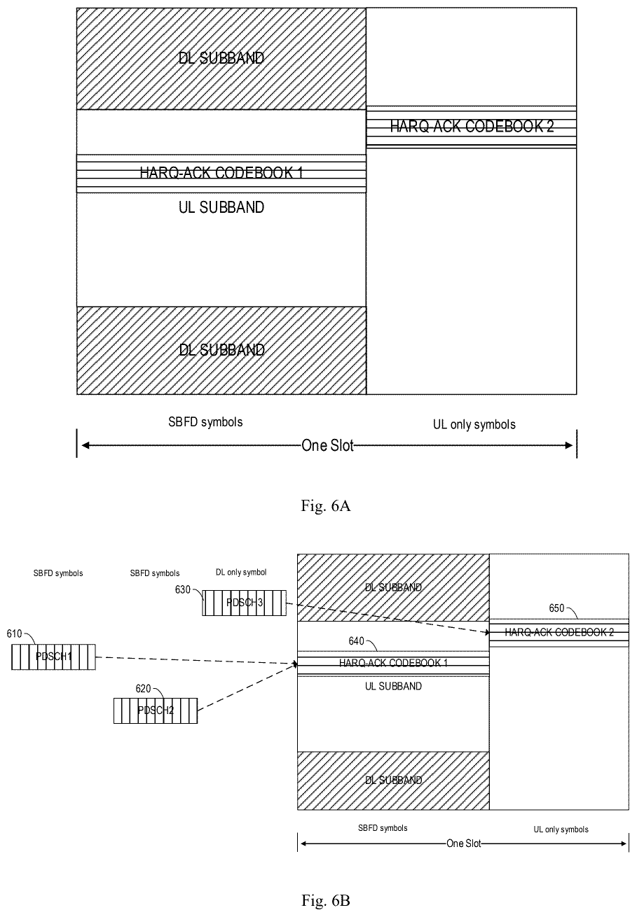

In addition, for the HARQ-ACK codebook having the second type (for example, type 2), the terminal device 110 device may determine (219) the HARQ-ACK for the previous downlink data based on location indication, priority location and/or transmit power command (TPC). For illustration purposes, the HARQ-ACK codebook is further discussed with reference to FIGS. 6A and 6B.

FIGS. 6A and 6B illustrate example HARQ-ACK codebooks in SBFD time units and non-SBFD time units according to some embodiments of the present disclosure.

As shown in FIG. 6A, two separate type-1 HARQ-ACK codebooks can be constructed for SBFD time units (for example, symbols) and non-SBFD time units (for example, symbols) in a slot. The HARQ-ACK feedback for SBFD slot set are multiplexed in one HARQ-ACK codebook or one PUCCH that is transmitted on the SBFD symbols.

In addition, for type2 HARQ-ACK codebook construction in slot n+k, one bit is introduced into the DCI that schedules physical downlink shared channel (PDSCH). The one bit may indicate which HARQ-ACK codebook is used for this PDSCH HARQ-ACK feedback. In an example, the bit “0” indicates that HARQ-ACK feedback on the HARQ-ACK codebook is configured for SBFD symbols, and the bit “1” indicates that the HARQ-ACK feedback on the HARQ-ACK codebook is configured for non-SBFD symbols. For example, the network device 120 may transmit a HARQ-ACK indication in a DCI signaling to the terminal device 110. The HARQ-ACK indication is indicative of whether a HARQ-ACK codebook having a second type in a time unit is configured for at least one previous SBFD time unit or at least one previous non-SBFD time unit, the time unit being the SBFD time unit or the non-SBFD time unit. With receiving this HARQ-ACK indication, the terminal device 110 may transmit, based on the HARQ-ACK indication, the HARQ-ACK codebook on the first resource set or the second resource set.

For the type 2 HARQ-ACK codebook construction, in addition or alternatively, a priority indication in the DCI format 1_1 may be reused to determine which HARQ-ACK codebook to include the HARQ-ACK of this scheduled PDSCH. In an example, the network device 120 may transmit a priority indication in a DCI signaling to the terminal device 110. The priority indication being associated with a HARQ-ACK codebook having a second type in a time unit (for example, the SBFD time unit or the non-SBFD time unit). In this case, the terminal device 110 may transmit the HARQ-ACK codebook on the first resource set or the second resource set based on the priority indication. For example, if a data traffic has a higher priority level, the terminal device 110 may transmit the corresponding HARQ-ACK codebook on the earlier one of the first resource set or the second resource set.

In addition or alternatively, the terminal device 110 may determine which HARQ-ACK codebook is used according to the TPC command. For example, the terminal device 110 may determine a TPC command for a HARQ-ACK codebook having a second type. Then, the terminal device 110 may transmit the HARQ-ACK codebook on the one of the first resource set or the second resource set that has the corresponding transmit power.

In addition, in some embodiments, the downlink assignment index is separately counted for the HARQ-ACK codebooks in the SBFD time unit and the HARQ-ACK codebooks in the non-SBFD time unit. That is, the DAI is separately counted for each codebook, and the PUCCH resource for each codebook is determined based on the latest DCI indication for HARQ-ACK feedback in this time unit.

As shown in FIG. 6B, for the type 1 HARQ-ACK codebook, the HARQ-ACK codebook 1 (640) in the SBFD symbol is configured for the PDSCH 1 and PDSCH 2 in the previous SBFD symbols. In addition, the HARQ-ACK codebook 2 (650) in the SBFD symbol is configured for the PDSCH 3 in the previous non-SBFD symbol (i.e., DL symbol). The PUCCH transmitted on SBFD symbols only carrying the HARQ-ACK for the scheduled PDSCH transmitted on the SBFD symbols. Furthermore, the PUCCH transmitted on UL symbols carrying the HARQ-ACK for the scheduled PDSCH transmitted on the DL symbols. As such, the HARQ-ACK feedback for PDSCH1 and PDSCH2 transmitted on the SBFD symbols will be transmitted on the PUCCH1 resource on the SBFD UL subband. The HARQ-ACK feedback for PDSCH3 transmitted on the DL only symbols will be transmitted on the PUCCH2 resource in UL only symbols.

Alternatively, for the type 2 HARQ-ACK codebook, there may be a HARQ-ACK indication, a priority indication and/or TPC command associated with the HARQ-ACK codebook in the DCI scheduling the PDSCH. Then, the terminal device 110 may transmit the HARQ-ACK on the corresponding HARQ-ACK codebook based on the HARQ-ACK indication, a priority indication and/or TPC command.

Referring back to FIG. 2, in some embodiments, the PUCCH repetitions may be adjusted considering the SBFD time unis and the non-SBFD time units.

In some embodiments, if continuous SBFD time units and non-SBFD time units fulfill a duration requirement of the plurality of uplink control channel repetitions and the plurality of continuous PUCCH repetitions is scheduled within the uplink frequency subband of the SBFD time units, the terminal device 110 may transmit the plurality of uplink control channel repetitions across the continuous the SBFD time units and the non-SBFD time units. In some embodiments, the first resource set and the second resource set may share the common resource set as mentioned above.

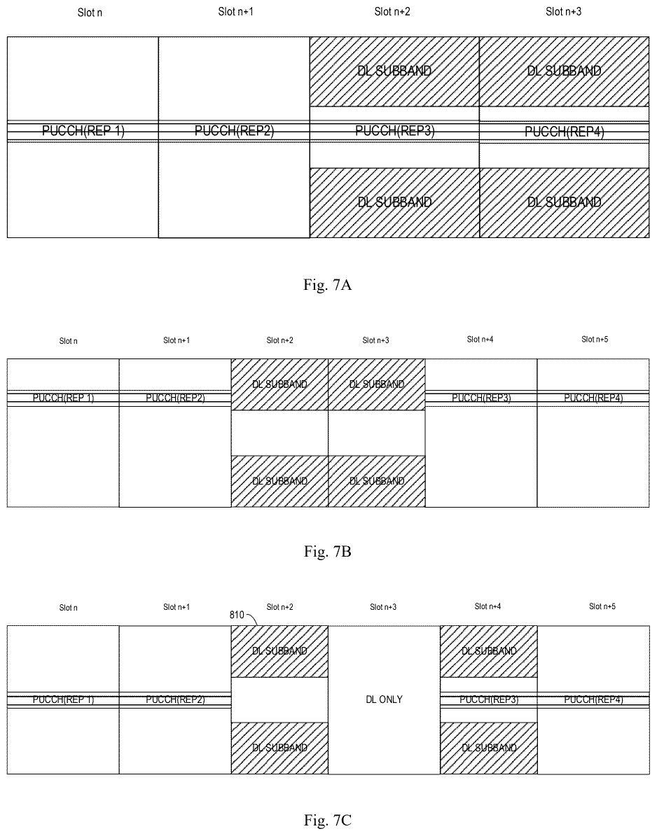

Otherwise, if the continuous SBFD time units and non-SBFD time units do not fulfill a duration requirement of the plurality of uplink control channel repetitions or the plurality of uplink control channel repetitions is not scheduled within a bandwidth of the uplink frequency subband of the SBFD time units, the terminal device 110 may transmit the plurality of uplink control channel repetitions on the non-SBFD time unit. For illustration purposes, the PUCCH repetitions are further discussed with reference to FIGS. 7A to 7C.

FIGS. 7A to 7C illustrate examples of uplink control channel repetitions on SBFD time units and non-SBFD time units according to some embodiments of the present disclosure.

As shown in FIG. 7A to 7C, if the SBFD resource is available for the duration of the PUCCH repetition transmission, then the PUCCH may be transmitted on the SBFD symbols. In addition, this repetition may be considered as one transmission.

Otherwise, if the SBFD resource is not available (for example, the PUCCH frequency resource fall into the DL subband or the SBFD symbols is less than the long PUCCH symbol number), then the PUCCH repetition will be deferred to the next available UL resource and the PUCCH will not transmitted on the SBFD symbols.

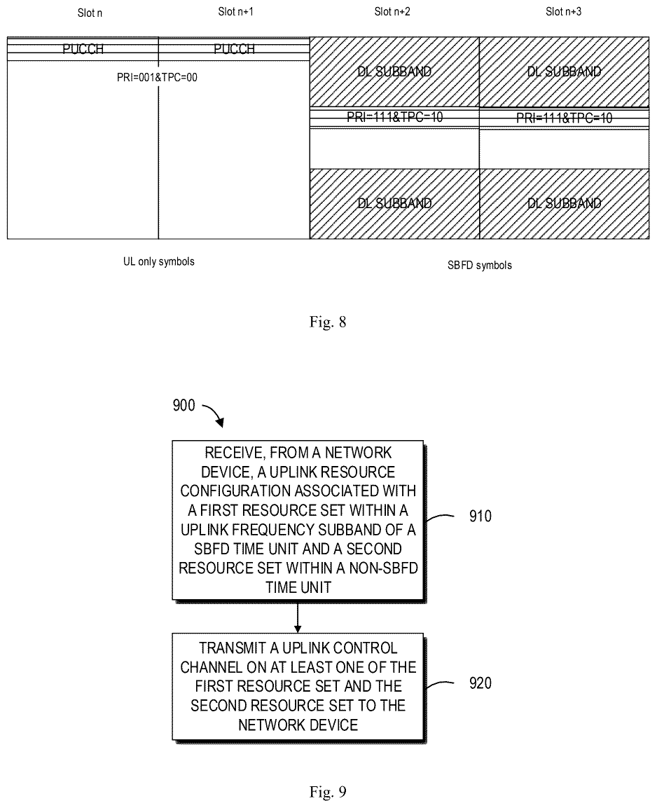

Referring back to FIG. 2, in some embodiments, for the PUCCH repetition transmission, two sets of allocation parameters can be included in the DCI for PUCCH transmission on SBFD symbols and non-SBFD symbols. In addition, the medium access control (MAC) control element (CE) may activate two different beam for PUCCH transmission on SBFD time units and PUCCH on non-SBFD time units. In some embodiments, the uplink resource configuration may comprise a first PRI and a first TPC command for the first resource set. Further, the uplink resource configuration may comprise comprises a second PRI and a second TPC command for the second resource set. This uplink resource configuration may be transmitted in the DCI. For illustration purposes, the two sets of allocation parameters are further discussed with reference to FIG. 8.

FIG. 8 illustrates example physical uplink control channel resource indicators (PRI) and transmit power control (TPC) commands for indicating uplink control channel resources on SBFD time units and non-SBFD time units according to some embodiments of the present disclosure.

As shown in FIG. 8, two TPC commands and two PRI bit fields are included in the DCI scheduling the PUCCH transmission. The two TPC command includes a first TPC command and a second TPC command. The two PRI bit fields include a first PRI bit field and a second PRI bit field. First parameter set comprising the first TPC command and the first PRI bit field is used for PUCCH transmission on SBFD symbols. Second parameter set comprising the second TPC command and the second PRI bit field is used for PUCCH transmission on non-SBFD symbols. That is, additional two bits for TPC command and three bits for PR are added in the DCI scheduling PDSCH for the PUCCH repetition transmission across SBFD symbols and non-SBFD symbols.

In the FIG. 8, two PRI values and two TPC values are included in the DCI format 1_1 scheduling the PDSCH. The two PRI values and two TPC values may indicate different TPC and PUCCH resource for SBFD slot and non-SBFD slot.

In this way, the PUCCH resource allocation is carefully designed with respect to SBFD time units, in order to improve system performance. In addition, the proposed PUCCH multiplexing procedure, PUCCH repetitions and HARQ-ACK are also adapted for the updated PUCCH resource allocation for the SBFD time unit.

FIG. 9 illustrates a flowchart of a method 900 of communication implemented at a terminal device in accordance with some embodiments of the present disclosure. The method 900 can be implemented at the terminal device 900 shown in FIG. 1. For the purpose of discussion, the method 900 will be described with reference to FIG. 1. It is to be understood that the method 900 may include additional acts not shown and/or may omit some shown acts, and the scope of the present disclosure is not limited in this regard.

At 910, the terminal device 110 transmits receives an uplink resource configuration from a network device. The uplink resource configuration is associated with a first resource set within an uplink frequency subband of a SBFD time unit and a second resource set within a non-SBFD time unit. The SBFD time unit is configured with frequency subbands for different link directions. At 920, the terminal device 110 transmits an uplink control channel on at least one of the first resource set and the second resource set to the network device 120.

In some embodiments, the resource configuration comprises a common resource set ID, the second resource set is indicated by the common resource set ID, and the first resource set is indicated by the common resource ID and at least one additional parameter.

In some embodiments, the at least one additional parameter is comprised in the uplink resource configuration, the at least one additional parameter being enabled for the SBFD time unit, and wherein the at least one additional parameter comprises at least one of: starting resource block parameter for the uplink control channel on the first resource set, intra slot frequency hopping parameter for the uplink control channel on the first resource set, second hopping resource block parameter for the uplink control channel on the first resource set, power control parameter for the uplink control channel, spatial beam parameter for the uplink control channel, and path loss reference signal parameter for the uplink control channel.

In some embodiments, the at least one additional parameter comprises a starting resource block offset value, and wherein the starting resource block offset value is preconfigured as zero.

In some embodiments, the terminal device 110 further receives an updated starting resource block offset value based on that the second resource set at least partially overlaps with a downlink frequency subband of the SBFD time unit in a frequency domain, the first resource set being determined by the updated starting resource block offset value and the second resource set.

In some embodiments, the common resource set ID is associated with intra-slot or inter-slot frequency hopping, and the at least one additional parameter further comprises a second hopping resource block offset value, and the second hopping resource block offset value is preconfigured or indicated by DCI signaling.

In some embodiments, the terminal device 110 further enables the intra-slot or inter-slot frequency hopping within the first resource set, such that the first resource set comprises a first frequency hopping resource and a second frequency hopping resource. The second frequency hopping resource is determined by the second hopping resource block offset value and another second frequency hopping resource of the second resource set.

In some embodiments, the terminal device 110 receives an updated second hopping resource block offset value based on that an second frequency hopping resource of the first resource set at least partially overlaps with a downlink frequency subband of the SBFD time unit in the frequency domain. The terminal device 110 updates the second hopping resource of the first resource set by the updated second hopping resource block offset value and the other second hopping resource of the second resource set.

In some embodiments, the terminal device 110 enables the intra-slot or inter-slot frequency hopping within the first resource set, such that the first resource set comprises a first frequency hopping resource and a second frequency hopping resource, and determines a frequency hopping resource block number between the first frequency hopping resource and the second frequency hopping resource by calculating: (the resource block number of a second frequency hopping resource plus the second hopping resource block offset value) mod (the number of resource blocks in the uplink frequency subband of the SBFD time unit minus the number of resource blocks in the first resource set).

In some embodiments, the terminal device 110, the terminal device 110 further enables the intra-slot or inter-slot frequency hopping within the first resource set, such that the first resource set comprises a first frequency hopping resource and a second frequency hopping resource, and determines a frequency hopping resource block number between the first frequency hopping resource and the second frequency hopping resource based on the number of resource blocks in the uplink frequency subband of the SBFD time unit.

In some embodiments, the terminal device 110 further disables the intra-slot or inter-slot frequency hopping within the first resource set.

In some embodiments, the terminal device 110 based on that continuous SBFD time units and non-SBFD time units fulfill a duration requirement of the plurality of uplink control channel repetitions and that the plurality of continuous uplink control channel repetitions is scheduled within the uplink frequency subband of the SBFD time units, transmits the plurality of uplink control channel repetitions across the continuous the SBFD time units and the non-SBFD time units.

In some embodiments, the terminal device 110 based on that continuous SBFD time units and non-SBFD time units do not fulfill a duration requirement of the plurality of uplink control channel repetitions or that the plurality of uplink control channel repetitions is not scheduled within a bandwidth of the uplink frequency subband of the SBFD time units, transmit the plurality of uplink control channel repetitions on the non-SBFD time unit.

In some embodiments, the terminal device 110 further receives configuration information of the uplink control channel, wherein the configuration information indicates that a duration of the uplink control channel crosses a boundary between the SBFD time unit and the non-SBFD time unit; and transmits the uplink control channel across the boundary.

In some embodiments, the uplink resource configuration comprises a SBFD resource configuration indicating the first resource set and a non-SBFD resource configuration indicating the second resource set, the SBFD resource configuration and the non-SBFD resource configuration being determined independently.

In some embodiments, the terminal device 110 transmits the uplink control channel by: multiplexing a first plurality of uplink control channels having at least one UCI type within the SBFD time unit to be a first multiplexed uplink control channel; multiplexing a second plurality of uplink control channels having at least one UCI type within the non-SBFD time unit to be a second multiplexed uplink control channel; and transmitting the first multiplexed uplink control channel on the first resource set and the second multiplexed uplink control channel on the second resource set separately.

In some embodiments, the terminal device 110 receives configuration information of the uplink control channel, wherein the configuration information indicates that a duration of the uplink control channel crosses a boundary between the SBFD time unit and the non-SBFD time unit; and drops the uplink control channel.

In some embodiments, the terminal device 110 transmits the uplink control channel by at least one of: transmitting a first HARQ-ACK codebook having a first type on the first resource set, the first HARQ-ACK being configured for a downlink shared channel transmitted on at least one previous SBFD time unit; and transmitting a second HARQ-ACK codebook having the first type on the second resource set, the second HARQ-ACK being configured for a downlink shared channel transmitted on at least one previous non-SBFD time unit.

In some embodiments, the terminal device 110 transmits the uplink control channel by: receiving a HARQ-ACK indication in a downlink control information (DCI) signaling, the HARQ-ACK indication being indicative of whether a HARQ-ACK codebook having a second type in a time unit is configured for at least one previous SBFD time unit or at least one previous non-SBFD time unit, the time unit being the SBFD time unit or the non-SBFD time unit; and transmitting, based on the HARQ-ACK indication, the HARQ-ACK codebook on the first resource set or the second resource set.

In some embodiments, the terminal device 110 transmits the uplink control channel by: receiving a priority indication in a downlink control information (DCI) signaling, the priority indication being associated with a HARQ-ACK codebook having a second type in a time unit, the time unit being the SBFD time unit or the non-SBFD time unit; and transmitting, based on the priority indication, the HARQ-ACK codebook on the first resource set or the second resource set.

In some embodiments, the terminal device 110 transmits the uplink control channel by: determining a transmit power control (TPC) command for a HARQ-ACK codebook having a second type; and transmitting, based on the TPC command, the HARQ-ACK codebook on the first resource set or the second resource set.

In some embodiments, the downlink assignment index is separately counted for the HARQ-ACK codebooks in the SBFD time unit and the HARQ-ACK codebooks in the non-SBFD time unit.

In some embodiments, the uplink resource configuration comprises a first physical uplink control channel resource indicator (PRI) and a first TPC command for the first resource set, the uplink resource configuration further comprises a second PRI and a second TPC command for the second resource set, and the uplink resource configuration is received by the terminal device in a DCI signaling.

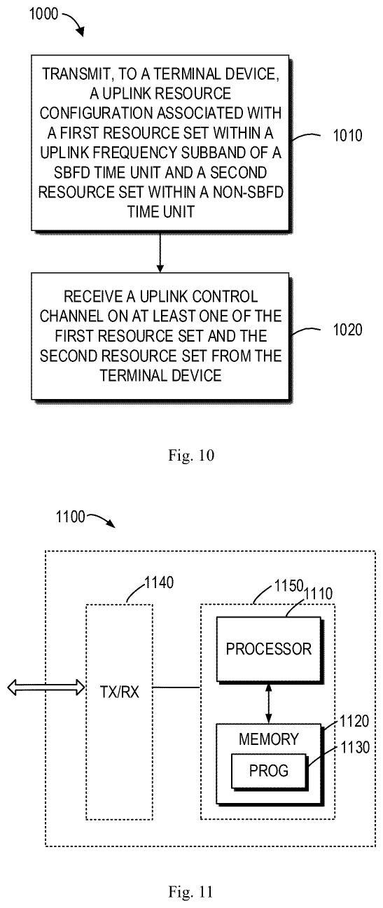

FIG. 10 illustrates a flowchart of a method 1000 of communication implemented at a network device in accordance with some embodiments of the present disclosure. The method 1000 can be implemented at the network device 120 shown in FIG. 1. For the purpose of discussion, the method 1000 will be described with reference to FIG. 1. It is to be understood that the method 1000 may include additional acts not shown and/or may omit some shown acts, and the scope of the present disclosure is not limited in this regard.

At 1010, the network device 120 transmits an uplink resource configuration to a terminal device. The uplink resource configuration is associated with a first resource set within an uplink frequency subband of a SBFD time unit and a second resource set within a non-SBFD time unit. The SBFD time unit is configured with frequency subbands for different link directions. The network device 120 receives an uplink control channel on at least one of the first resource set and the second resource set from the terminal device.

In some embodiments, the resource configuration comprises a common resource set identification (ID), the second resource set is indicated by the common resource set ID, and the first resource set is indicated by the common resource ID and at least one additional parameter.

In some embodiments, the at least one additional parameter is comprised in the uplink resource configuration, the at least one additional parameter being enabled for the SBFD time unit, and wherein the at least one additional parameter comprises at least one of: starting resource block parameter for the uplink control channel on the first resource set, intra slot frequency hopping parameter for the uplink control channel on the first resource set, second hopping resource block parameter for the uplink control channel on the first resource set, power control parameter for the uplink control channel, spatial beam parameter for the uplink control channel, and path loss reference signal parameter for the uplink control channel.

In some embodiments, the at least one additional parameter comprises a starting resource block offset value, and wherein the starting resource block offset value is preconfigured as zero.

In some embodiments, the network device 120 further transmits an updated starting resource block offset value based on that the second resource set at least partially overlaps with a downlink frequency subband of the SBFD time unit in a frequency domain. The first resource set is determined by the updated starting resource block offset value and the second resource set.

In some embodiments, the common resource set ID is associated with intra-slot or inter-slot frequency hopping, and the at least one additional parameter further comprises a second hopping resource block offset value, the second hopping resource block offset value is preconfigured or indicated by downlink control information (DCI) signaling.

In some embodiments, the network device 120 further enables the intra-slot or inter-slot frequency hopping within the first resource set, such that the first resource set comprises a first frequency hopping resource a second frequency hopping resource, the second frequency hopping resource being determined by the second hopping resource block offset value and another second frequency hopping resource of the second resource set.

In some embodiments, the network device 120 further transmits an updated second hopping resource block offset value based on that a second hopping resource of the first resource set at least partially overlaps with a downlink frequency subband of the SBFD time unit in the frequency domain; and updates the second hopping resource of the first resource set by the updated second hopping resource block offset value and the other second frequency hopping resource of the second resource set.

In some embodiments, the network device 120 further enables the intra-slot or inter-slot frequency hopping within the first resource set, such that the first resource set comprises a first frequency hopping resource and a second frequency hopping resource, and determines a frequency hopping resource block number between the first frequency hopping resource and the second frequency hopping resource by calculating: (the resource block number of a second frequency hopping resource plus the second hopping resource block offset value) mod (the number of resource blocks in the uplink frequency subband of the SBFD time unit minus the number of resource blocks in the first resource set).

In some embodiments, the network device 120 further enables the intra-slot or inter-slot frequency hopping within the first resource set, such that the first resource set comprises a first frequency hopping resource, and determines a frequency hopping resource block number between the first frequency hopping resource and the second frequency hopping resource based on the number of resource blocks in the uplink frequency subband of the SBFD time unit.

In some embodiments, the network device 120 further disables the intra-slot or inter-slot frequency hopping within the first resource set.

In some embodiments, the network device 120 further based on that continuous SBFD time units and non-SBFD time units fulfill a duration requirement of the plurality of uplink control channel repetitions and that the plurality of continuous uplink control channel repetitions is scheduled within the uplink frequency subband, receives the plurality of uplink control channel repetitions across the continuous SBFD time units and non-SBFD time units.

In some embodiments, the network device 120 further based on that continuous SBFD time units and non-SBFD time units do not fulfill a duration requirement of the plurality of uplink control channel repetitions or that the plurality of uplink control channel repetitions is not scheduled within a bandwidth of the first resource set, receive the plurality of uplink control channel repetitions on the non-SBFD time unit.

In some embodiments, the network device 120 further transmits configuration information of the uplink control channel, wherein the configuration information indicates that a duration of the uplink control channel crosses a boundary between the SBFD time unit and the non-SBFD time unit; and receives the uplink control channel across the boundary.

In some embodiments, the uplink resource configuration comprises a SBFD resource configuration indicating the first resource set and a non-SBFD resource configuration indicating the second resource set, the SBFD resource configuration and the non-SBFD resource configuration being determined independently.

In some embodiments, the network device 120 transmits the uplink control channel by at least one of: receiving a first hybrid automatic repeat request-acknowledge (HARQ-ACK) codebook having a first type on the first resource set, the first HARQ-ACK being configured for a downlink shared channel transmitted on at least one previous SBFD time unit; and receiving a second HARQ-ACK codebook having the first type on the second resource set, the second HARQ-ACK being configured for a downlink shared channel transmitted on at least one previous non-SBFD time unit.

In some embodiments, the network device 120 receive the uplink control channel by: transmitting a HARQ-ACK indication in a downlink control information (DCI) signaling, the HARQ-ACK indication being indicative of whether a HARQ-ACK codebook having a second type in a time unit is configured for at least one previous SBFD time unit or at least one previous non-SBFD time unit, the time unit being the SBFD time unit or the non-SBFD time unit; and receiving, based on the HARQ-ACK indication, the HARQ-ACK codebook on the first resource set or the second resource set.

In some embodiments, the network device 120 receives the uplink control channel by: transmitting a priority indication in a DCI signaling, the priority indication being associated with a HARQ-ACK codebook having a second type in a time unit, the time unit being the SBFD time unit or the non-SBFD time unit; and receiving, based on the priority indication, the HARQ-ACK codebook on the first resource set or the second resource set.

In some embodiments, the network device 120 receives the uplink control channel by: determining a transmit power control (TPC) command for a HARQ-ACK codebook having a second type; and receiving, based on the TPC command, the HARQ-ACK codebook on the first resource set or the second resource set.

In some embodiments, the downlink assignment index is separately counted for the HARQ-ACK codebooks in the SBFD time unit and the HARQ-ACK codebooks in the non-SBFD time unit.

In some embodiments, the uplink resource configuration comprises a first physical uplink control channel resource indicator (PRI) and a first TPC command for the first resource set, the uplink resource configuration further comprises a second PRI and a second TPC command for the second resource set, and the uplink resource configuration is transmitted by the network device in a DCI signaling.

FIG. 11 is a simplified block diagram of a device 1100 that is suitable for implementing some embodiments of the present disclosure. The device 1100 can be considered as a further example embodiment of the terminal device 110 or network device 120 as shown in FIG. 1. Accordingly, the device 1100 can be implemented at or as at least a part of the above network devices or terminal devices.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1120 stores at least a part of a program 11730. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between gNBs or eNBs, SI interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1130 is assumed to include program instructions that, when executed by the associated processor 1110, enable the device 1100 to operate in accordance with the embodiments of the present disclosure, as discussed herein with reference to FIGS. 1-16. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

In some embodiments, a terminal device comprises circuitry configured to perform method 900.

In some embodiments, a network device comprises circuitry configured to perform method 1000.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, technique terminal devices or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

In summary, embodiments of the present disclosure may provide the following solutions.

A terminal device comprises a transceiver and a processor communicatively coupled to the transceiver. The processor is configured to cause the terminal device to: receive an uplink resource configuration from a network device. The uplink resource configuration is associated with a first resource set within an uplink frequency subband of a SBFD time unit and a second resource set within a non-SBFD time unit. The SBFD time unit is configured with frequency subbands for different link directions. The terminal device is further caused to transmit an uplink control channel on at least one of the first resource set and the second resource set to the network device.

In one embodiment, wherein: the resource configuration comprises a common resource set identification (ID), the second resource set is indicated by the common resource set ID, and the first resource set is indicated by the common resource ID and at least one additional parameter.

In one embodiment, wherein the at least one additional parameter is comprised in the uplink resource configuration, the at least one additional parameter being enabled for the SBFD time unit, and wherein the at least one additional parameter comprises at least one of: starting resource block parameter for the uplink control channel on the first resource set, intra slot frequency hopping parameter for the uplink control channel on the first resource set, second hopping resource block parameter for the uplink control channel on the first resource set, power control parameter for the uplink control channel, spatial beam parameter for the uplink control channel, and path loss reference signal parameter for the uplink control channel.

In one embodiment, wherein the at least one additional parameter comprises a starting resource block offset value, and wherein the starting resource block offset value is preconfigured as zero.

In one embodiment, wherein the terminal device is further caused to: receive an updated starting resource block offset value based on that the second resource set at least partially overlaps with a downlink frequency subband of the SBFD time unit in a frequency domain, the first resource set being determined by the updated starting resource block offset value and the second resource set.

In one embodiment, the common resource set ID is associated with intra-slot or inter-slot frequency hopping, and the at least one additional parameter further comprises a second hopping resource block offset value, and the second hopping resource block offset value is preconfigured or indicated by downlink control information (DCI) signaling.

In one embodiment, wherein the terminal device is further caused to: enable the intra-slot or inter-slot frequency hopping within the first resource set, such that the first resource set comprises a first frequency hopping resource and a second frequency hopping resource, the second frequency hopping resource being determined by the second hopping resource block offset value and another second frequency hopping resource of the second resource set.

In one embodiment, wherein the terminal device is further caused to: receive an updated second hopping resource block offset value based on that an second frequency hopping resource of the first resource set at least partially overlaps with a downlink frequency subband of the SBFD time unit in the frequency domain; and update the second hopping resource of the first resource set by the updated second hopping resource block offset value and the other second hopping resource of the second resource set.

In one embodiment, wherein the terminal device is further caused to: enable the intra-slot or inter-slot frequency hopping within the first resource set, such that the first resource set comprises a first frequency hopping resource and a second frequency hopping resource, and determine a frequency hopping resource block number between the first frequency hopping resource and the second frequency hopping resource by calculating: (the resource block number of a second frequency hopping resource plus the second hopping resource block offset value) mod (the number of resource blocks in the uplink frequency subband of the SBFD time unit minus the number of resource blocks in the first resource set).

In one embodiment, wherein the terminal device is further caused to enable the intra-slot or inter-slot frequency hopping within the first resource set, such that the first resource set comprises a first frequency hopping resource and a second frequency hopping resource, and determine a frequency hopping resource block number between the first frequency hopping resource and the second frequency hopping resource based on the number of resource blocks in the uplink frequency subband of the SBFD time unit.

In one embodiment, wherein the terminal device is further caused to: disable the intra-slot or inter-slot frequency hopping within the first resource set.

In one embodiment, wherein the terminal device is further caused to: based on that continuous SBFD time units and non-SBFD time units fulfill a duration requirement of the plurality of uplink control channel repetitions and that the plurality of continuous uplink control channel repetitions is scheduled within the uplink frequency subband of the SBFD time units, transmit the plurality of uplink control channel repetitions across the continuous the SBFD time units and the non-SBFD time units.

In one embodiment, wherein the terminal device is further caused to: based on that continuous SBFD time units and non-SBFD time units do not fulfill a duration requirement of the plurality of uplink control channel repetitions or that the plurality of uplink control channel repetitions is not scheduled within a bandwidth of the uplink frequency subband of the SBFD time units, transmit the plurality of uplink control channel repetitions on the non-SBFD time unit.

In one embodiment, wherein the terminal device is further caused to: receive configuration information of the uplink control channel, wherein the configuration information indicates that a duration of the uplink control channel crosses a boundary between the SBFD time unit and the non-SBFD time unit; and transmit the uplink control channel across the boundary.

In one embodiment, wherein the uplink resource configuration comprises a SBFD resource configuration indicating the first resource set and a non-SBFD resource configuration indicating the second resource set, the SBFD resource configuration and the non-SBFD resource configuration being determined independently.

In one embodiment, wherein the terminal device is caused to transmit the uplink control channel by: multiplexing a first plurality of uplink control channels having at least one uplink control information (UCI) type within the SBFD time unit to be a first multiplexed uplink control channel; multiplexing a second plurality of uplink control channels having at least one UCI type within the non-SBFD time unit to be a second multiplexed uplink control channel; and transmitting the first multiplexed uplink control channel on the first resource set and the second multiplexed uplink control channel on the second resource set separately.

In one embodiment, wherein the terminal device is further caused to: receive configuration information of the uplink control channel, wherein the configuration information indicates that a duration of the uplink control channel crosses a boundary between the SBFD time unit and the non-SBFD time unit; and drop the uplink control channel.

In one embodiment, wherein the terminal device is caused to transmit the uplink control channel by at least one of: transmitting a first hybrid automatic repeat request-acknowledge (HARQ-ACK) codebook having a first type on the first resource set, the first HARQ-ACK being configured for a downlink shared channel transmitted on at least one previous SBFD time unit; and transmitting a second HARQ-ACK codebook having the first type on the second resource set, the second HARQ-ACK being configured for a downlink shared channel transmitted on at least one previous non-SBFD time unit.

In one embodiment, wherein the terminal device is caused to transmit the uplink control channel by: receiving a HARQ-ACK indication in a downlink control information (DCI) signaling, the HARQ-ACK indication being indicative of whether a HARQ-ACK codebook having a second type in a time unit is configured for at least one previous SBFD time unit or at least one previous non-SBFD time unit, the time unit being the SBFD time unit or the non-SBFD time unit; and transmitting, based on the HARQ-ACK indication, the HARQ-ACK codebook on the first resource set or the second resource set.

In one embodiment, wherein the terminal device is caused to transmit the uplink control channel by: receiving a priority indication in a DCI signaling, the priority indication being associated with a HARQ-ACK codebook having a second type in a time unit, the time unit being the SBFD time unit or the non-SBFD time unit; and transmitting, based on the priority indication, the HARQ-ACK codebook on the first resource set or the second resource set.

In one embodiment, wherein the terminal device is caused to transmit the uplink control channel by: determining a transmit power control (TPC) command for a HARQ-ACK codebook having a second type; and transmitting, based on the TPC command, the HARQ-ACK codebook on the first resource set or the second resource set.

In one embodiment, wherein the downlink assignment index is separately counted for the HARQ-ACK codebooks in the SBFD time unit and the HARQ-ACK codebooks in the non-SBFD time unit.

In one embodiment, wherein: the uplink resource configuration comprises a first physical uplink control channel resource indicator (PRI) and a first TPC command for the first resource set, the uplink resource configuration further comprises a second PRI and a second TPC command for the second resource set, and the uplink resource configuration is received by the terminal device in a DCI signaling.

A network device comprises a transceiver and a processor communicatively coupled to the transceiver. The processor is configured to cause the network device to: transmit an uplink resource configuration to a terminal device. The uplink resource configuration is associated with a first resource set within an uplink frequency subband of a SBFD time unit and a second resource set within a non-SBFD time unit. The SBFD time unit is configured with frequency subbands for different link directions. The network device is further caused to receive an uplink control channel on at least one of the first resource set and the second resource set from the terminal device.

In one embodiment, wherein: the resource configuration comprises a common resource set identification (ID), the second resource set is indicated by the common resource set ID, and the first resource set is indicated by the common resource ID and at least one additional parameter.

In one embodiment, wherein the at least one additional parameter is comprised in the uplink resource configuration, the at least one additional parameter being enabled for the SBFD time unit, and wherein the at least one additional parameter comprises at least one of: starting resource block parameter for the uplink control channel on the first resource set, intra slot frequency hopping parameter for the uplink control channel on the first resource set, second hopping resource block parameter for the uplink control channel on the first resource set, power control parameter for the uplink control channel, spatial beam parameter for the uplink control channel, and/or path loss reference signal parameter for the uplink control channel.

In one embodiment, wherein the at least one additional parameter comprises a starting resource block offset value, and wherein the starting resource block offset value is preconfigured as zero.

In one embodiment, wherein the terminal device is further caused to: transmit an updated starting resource block offset value based on that the second resource set at least partially overlaps with a downlink frequency subband of the SBFD time unit in a frequency domain, the first resource set being determined by the updated starting resource block offset value and the second resource set.

In one embodiment, wherein: the common resource set ID is associated with intra-slot or inter-slot frequency hopping, and the at least one additional parameter further comprises a second hopping resource block offset value, the second hopping resource block offset value is preconfigured or indicated by downlink control information (DCI) signaling.

In one embodiment, wherein the network device is further caused to: enable the intra-slot or inter-slot frequency hopping within the first resource set, such that the first resource set comprises a first frequency hopping resource a second frequency hopping resource, the second frequency hopping resource being determined by the second hopping resource block offset value and another second frequency hopping resource of the second resource set.

In one embodiment, wherein the network device is further caused to: transmit an updated second hopping resource block offset value based on that a second hopping resource of the first resource set at least partially overlaps with a downlink frequency subband of the SBFD time unit in the frequency domain; and update the second hopping resource of the first resource set by the updated second hopping resource block offset value and the other second frequency hopping resource of the second resource set.

In one embodiment, wherein the network device is further caused to enable the intra-slot or inter-slot frequency hopping within the first resource set, such that the first resource set comprises a first frequency hopping resource and a second frequency hopping resource, and determine a frequency hopping resource block number between the first frequency hopping resource and the second frequency hopping resource by calculating: (the resource block number of a second frequency hopping resource plus the second hopping resource block offset value) mod (the number of resource blocks in the uplink frequency subband of the SBFD time unit minus the number of resource blocks in the first resource set).

In one embodiment, wherein the network device is further caused to enable the intra-slot or inter-slot frequency hopping within the first resource set, such that the first resource set comprises a first frequency hopping resource, and determine a frequency hopping resource block number between the first frequency hopping resource and the second frequency hopping resource based on the number of resource blocks in the uplink frequency subband of the SBFD time unit.

In one embodiment, wherein the network device is further caused to: disable the intra-slot or inter-slot frequency hopping within the first resource set.

In one embodiment, wherein the network device is further caused to: based on that continuous SBFD time units and non-SBFD time units fulfill a duration requirement of the plurality of uplink control channel repetitions and that the plurality of continuous uplink control channel repetitions is scheduled within the uplink frequency subband, receive the plurality of uplink control channel repetitions across the continuous SBFD time units and non-SBFD time units.

In one embodiment, wherein the network device is further caused to: based on that continuous SBFD time units and non-SBFD time units do not fulfill a duration requirement of the plurality of uplink control channel repetitions or that the plurality of uplink control channel repetitions is not scheduled within a bandwidth of the first resource set, receive the plurality of uplink control channel repetitions on the non-SBFD time unit.

In one embodiment, wherein the network device is further caused to: transmit configuration information of the uplink control channel, wherein the configuration information indicates that a duration of the uplink control channel crosses a boundary between the SBFD time unit and the non-SBFD time unit; and receive the uplink control channel across the boundary.

In one embodiment, wherein the uplink resource configuration comprises a SBFD resource configuration indicating the first resource set and a non-SBFD resource configuration indicating the second resource set, the SBFD resource configuration and the non-SBFD resource configuration being determined independently.

In one embodiment, wherein the network device is caused to receive the uplink control channel by at least one of: receiving a first hybrid automatic repeat request-acknowledge (HARQ-ACK) codebook having a first type on the first resource set, the first HARQ-ACK being configured for a downlink shared channel transmitted on at least one previous SBFD time unit; and receiving a second HARQ-ACK codebook having the first type on the second resource set, the second HARQ-ACK being configured for a downlink shared channel transmitted on at least one previous non-SBFD time unit.

In one embodiment, wherein the network device is caused to receive the uplink control channel by: transmitting a HARQ-ACK indication in a downlink control information (DCI) signaling, the HARQ-ACK indication being indicative of whether a HARQ-ACK codebook having a second type in a time unit is configured for at least one previous SBFD time unit or at least one previous non-SBFD time unit, the time unit being the SBFD time unit or the non-SBFD time unit; and receiving, based on the HARQ-ACK indication, the HARQ-ACK codebook on the first resource set or the second resource set.

In one embodiment, wherein the network device is caused to receive the uplink control channel by: transmitting a priority indication in a DCI signaling, the priority indication being associated with a HARQ-ACK codebook having a second type in a time unit, the time unit being the SBFD time unit or the non-SBFD time unit; and receiving, based on the priority indication, the HARQ-ACK codebook on the first resource set or the second resource set.

In one embodiment, wherein the network device is caused to receive the uplink control channel by: determining a transmit power control (TPC) command for a HARQ-ACK codebook having a second type; and receiving, based on the TPC command, the HARQ-ACK codebook on the first resource set or the second resource set.

In one embodiment, wherein the downlink assignment index is separately counted for the HARQ-ACK codebooks in the SBFD time unit and the HARQ-ACK codebooks in the non-SBFD time unit.

In one embodiment, wherein: the uplink resource configuration comprises a first physical uplink control channel resource indicator (PRI) and a first TPC command for the first resource set, the uplink resource configuration further comprises a second PRI and a second TPC command for the second resource set, and the uplink resource configuration is transmitted by the network device in a DCI signaling.

What is claimed is:

1. A terminal device comprising:
a transceiver; and
a processor communicatively coupled to the transceiver, and the processor is configured to cause the terminal device to:
receive, from a network device, an uplink resource configuration associated with a first resource set within an uplink frequency subband of a subband non-overlapping full duplex (SBFD) time unit and a second resource set within a non-SBFD time unit, the SBFD time unit being configured with frequency subbands for different link directions;
transmit, to the network device, an uplink control channel on at least one of the first resource set and the second resource set.

2. The terminal device of claim 1, wherein:
the resource configuration comprises a common resource set identification (ID),
the second resource set is indicated by the common resource set ID, and
the first resource set is indicated by the common resource ID and at least one additional parameter.

3. The terminal device of claim 2, wherein the at least one additional parameter is comprised in the uplink resource configuration, the at least one additional parameter being enabled for the SBFD time unit, and wherein the at least one additional parameter comprises at least one of:
starting resource block parameter for the uplink control channel on the first resource set,
intra slot frequency hopping parameter for the uplink control channel on the first resource set,
second hopping resource block parameter for the uplink control channel on the first resource set,
power control parameter for the uplink control channel,
spatial beam parameter for the uplink control channel, and
path loss reference signal parameter for the uplink control channel.

4. The terminal device of claim 2, wherein the at least one additional parameter comprises a starting resource block offset value, and wherein the starting resource block offset value is preconfigured as zero.

5. The terminal device of claim 4, wherein the terminal device is further caused to:
receive an updated starting resource block offset value based on that the second resource set at least partially overlaps with a downlink frequency subband of the SBFD time unit in a frequency domain, the first resource set being determined by the updated starting resource block offset value and the second resource set.

6. The terminal device of claim 4, wherein:
the common resource set ID is associated with intra-slot or inter-slot frequency hopping, and the at least one additional parameter further comprises a second hopping resource block offset value, and
the second hopping resource block offset value is preconfigured or indicated by downlink control information (DCI) signaling.

7. The terminal device of claim 6, wherein the terminal device is further caused to:
receive an updated second hopping resource block offset value based on that an second frequency hopping resource of the first resource set at least partially overlaps with a downlink frequency subband of the SBFD time unit in the frequency domain; and
update the second hopping resource of the first resource set by the updated second hopping resource block offset value and the other second hopping resource of the second resource set.

8. The terminal device of claim 6, wherein the terminal device is further caused to:
enable the intra-slot or inter-slot frequency hopping within the first resource set, such that the first resource set comprises a first frequency hopping resource and a second frequency hopping resource, and
determine a frequency hopping resource block number between the first frequency hopping resource and the second frequency hopping resource by calculating:
(the resource block number of a second frequency hopping resource plus the second hopping resource block offset value) mod (the number of resource blocks in the uplink frequency subband of the SBFD time unit minus the number of resource blocks in the first resource set).

9. The terminal device of claim 2, wherein the terminal device is further caused to:
based on that continuous SBFD time units and non-SBFD time units fulfill a duration requirement of the plurality of uplink control channel repetitions and that the plurality of continuous uplink control channel repetitions is scheduled within the uplink frequency subband of the SBFD time units, transmit the plurality of uplink control channel repetitions across the continuous the SBFD time units and the non-SBFD time units.

10. The terminal device of claim 2, wherein the terminal device is further caused to:
based on that continuous SBFD time units and non-SBFD time units do not fulfill a duration requirement of the plurality of uplink control channel repetitions or that the plurality of uplink control channel repetitions is not scheduled within a bandwidth of the uplink frequency subband of the SBFD time units, transmit the plurality of uplink control channel repetitions on the non-SBFD time unit.

11. The terminal device of claim 2, wherein the terminal device is further caused to:
receive configuration information of the uplink control channel, wherein the configuration information indicates that a duration of the uplink control channel crosses a boundary between the SBFD time unit and the non-SBFD time unit; and
transmit the uplink control channel across the boundary.

12. The terminal device of claim 1, wherein the uplink resource configuration comprises a SBFD resource configuration indicating the first resource set and a non-SBFD resource configuration indicating the second resource set, the SBFD resource configuration and the non-SBFD resource configuration being determined independently.

13. The terminal device of claim 12, wherein the terminal device is caused to transmit the uplink control channel by:
multiplexing a first plurality of uplink control channels having at least one uplink control information (UCI) type within the SBFD time unit to be a first multiplexed uplink control channel;
multiplexing a second plurality of uplink control channels having at least one UCI type within the non-SBFD time unit to be a second multiplexed uplink control channel; and
transmitting the first multiplexed uplink control channel on the first resource set and the second multiplexed uplink control channel on the second resource set separately.

14. The terminal device of claim 12, wherein the terminal device is further caused to:
receive configuration information of the uplink control channel, wherein the configuration information indicates that a duration of the uplink control channel crosses a boundary between the SBFD time unit and the non-SBFD time unit; and
drop the uplink control channel.

15. The terminal device of claim 1, wherein the terminal device is caused to transmit the uplink control channel by at least one of:
transmitting a first hybrid automatic repeat request-acknowledge (HARQ-ACK) codebook having a first type on the first resource set, the first HARQ-ACK being configured for a downlink shared channel transmitted on at least one previous SBFD time unit; and
transmitting a second HARQ-ACK codebook having the first type on the second resource set, the second HARQ-ACK being configured for a downlink shared channel transmitted on at least one previous non-SBFD time unit.

16. The terminal device of claim 1, wherein the terminal device is caused to transmit the uplink control channel by:
receiving a HARQ-ACK indication in a downlink control information (DCI) signaling, the HARQ-ACK indication being indicative of whether a HARQ-ACK codebook having a second type in a time unit is configured for at least one previous SBFD time unit or at least one previous non-SBFD time unit, the time unit being the SBFD time unit or the non-SBFD time unit; and
transmitting, based on the HARQ-ACK indication, the HARQ-ACK codebook on the first resource set or the second resource set.

17. The terminal device of claim 1, wherein the terminal device is caused to transmit the uplink control channel by:
receiving a priority indication in a DCI signaling, the priority indication being associated with a HARQ-ACK codebook having a second type in a time unit, the time unit being the SBFD time unit or the non-SBFD time unit; and
transmitting, based on the priority indication, the HARQ-ACK codebook on the first resource set or the second resource set.

18. The terminal device of claim 1, wherein the terminal device is caused to transmit the uplink control channel by:
determining a transmit power control (TPC) command for a HARQ-ACK codebook having a second type; and
transmitting, based on the TPC command, the HARQ-ACK codebook on the first resource set or the second resource set.

19. The terminal device of any of claims 16-18, wherein the downlink assignment index is separately counted for the HARQ-ACK codebooks in the SBFD time unit and the HARQ-ACK codebooks in the non-SBFD time unit.

20. The terminal device of claim 1, wherein:
the uplink resource configuration comprises a first physical uplink control channel resource indicator (PRI) and a first TPC command for the first resource set,
the uplink resource configuration further comprises a second PRI and a second TPC command for the second resource set, and
the uplink resource configuration is received by the terminal device in a DCI signaling.
